(19) United States
(12) Patent Application Publication
(10) Pub. No.: US 2008/0278472 A1
(43) Pub. Date: Nov. 13, 2008

(54) Display Unit

(75) Inventors: Hjalmar Edzer Ayco Huitema, Eindhoven (NL); Laurens R.R. Schrijnemakers, Eindhoven (NL); Petrus Johannes Gerardus Van Lieshout, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,192

(22) PCT Filed: Mar. 15, 2005
(86) PCT No.: PCT/IB2005/050908

§ 371 Date: Sep. 22, 2006

(30) Foreign Application Priority Data
Mar. 25, 2004 (EP) 04101240.2

(51) Int. Cl. G06F 3/038

(52) U.S. Cl. 345/212

(57) ABSTRACT

Display units (1) comprise selection circuitry (40) for selecting a line (41, 45, 49) during a period of a first duration. As a result, this period must be chosen equal to the duration to the smallest data pulse, and relatively high clock frequency is to be used for the selection circuitry (40). By introducing means (30, 60, 70, 80, 90) for supplying a data signal comprising a pulse of a second duration which is different from a first duration of a selection signal for selecting a line (41, 45, 49), now a data signal can be supplied to a pixel independently from the clock frequency of the selection circuitry (40). As a result, the selection circuitry (40) can be operated at a relatively low clock frequency, which reduces the power consumption. Preferably, the second duration is shorter than the first duration, and the means comprise common electrode circuitry (60), storage capacitor circuitry (70), and circuitry (80, 90) to be added to the selection circuitry (40) and the data circuitry (30).

The invention relates to a display unit, to a display device comprising a display unit, to a method for driving a display unit and to a processor program product for driving a display unit.

Examples of display devices of this type are monitors, laptop computers, personal digital assistants (PDAs), mobile telephones and electronic books, electronic newspapers, and electronic magazines.

A prior art display unit is generally known and comprises pixels arranged in rows and columns. Each pixel is coupled to a common electrode or counter electrode and is coupled via a pixel electrode to the drain of a transistor, of which the source is coupled to a column electrode or data electrode and of which the gate is coupled to a row electrode or selection electrode. This arrangement of pixels, transistors and row and column electrodes jointly forms an active matrix. A row driver (select driver) supplies a row driving signal or a selection signal for selecting a row of pixels and the column driver (data driver) supplies column driving signals or data signals to the selected row of pixels via the column electrodes and the transistors.

Each pixel for example corresponds with a microcapsule comprising charged particles. In dependence of a positive or negative voltage applied to the pixel electrode, the particles move, and the pixel becomes white/colored or appears dark to a viewer. When the electric voltage is removed, the display unit remains in the acquired state and exhibits a bi-stable character.

The time-interval required for driving all pixels in all rows once (by driving each row one after the other and by driving all columns simultaneously once per row) is called a frame. Per frame, each data signal for driving a pixel requires, per row, a row driving action for supplying the row driving signal (the selection signal) to the row for selecting (driving) this row, and a column driving action for supplying the data signal, like for example a data pulse, to the pixel. The latter is done for all pixels in a row simultaneously.

During an image update time-interval for example comprising twenty frames, an image is updated. During subsequent frames, the data signals are supplied, with a data signal having a duration of zero, one, two to for example fifteen frame periods. Thereby, a data signal having a duration of zero frame periods, for example, corresponds with the pixel displaying full black assuming that the pixel already displayed full black. In case the pixel displayed a certain gray value, this gray value remains unchanged when the pixel is driven with a data signal having a duration of zero frame periods, in other words when being driven with a data pulse having a zero amplitude. A data signal having, for example, a duration of fifteen frame periods comprises fifteen data pulses and results in the pixel displaying full white, and a data signal having a duration of one to fourteen frame periods, for example, comprises one to fourteen data pulses and results in the pixel displaying one of a limited number of gray values between full black and full white.

So, during a row driving action or selection action, the data pulses are supplied in parallel to the pixels in a particular row. Therefore, each data pulse has a duration substantially equal to the duration of the row driving action, in other words substantially equal to the duration of the selection signal. As a result, a given duration of the selection signal or, in other words, a given clock frequency of the select driver defines the width of the data pulses. Vice versa, a given width of a data pulse defines a required clock frequency of the select driver.

The known display unit is disadvantageous, inter alia, due to a data pulse having a smallest width defining the minimum clock frequency to be used. This clock frequency is relatively high. The relatively high clock frequency results in a relatively high power consumption.

It is an object of the invention, inter alia, to provide a display unit in which a data pulse having a relatively small width can be provided to a pixel where the select driver is clocked at a relatively low clock frequency.

Further objects of the invention are, inter alia, to provide a display device comprising a display unit in which a data pulse having a relatively small width can be provided to a pixel where the select driver is clocked at a relatively low clock frequency, and to provide a method for driving a display unit and a processor program product for driving a display unit, for use in (combination with) a display unit in which a data pulse having a relatively small width can be provided to a pixel where the select driver is clocked at a relatively low clock frequency.

A display unit according to the invention comprises

a display panel with bi-stable pixels;

selection circuitry for, during a period of a first duration, selecting a line with pixels; and

means for supplying a data signal to a pixel, which data signal comprises a pulse of a second duration, which second duration is different from the first duration.

By introducing the means for supplying the data signal comprising the pulse of the second duration which is different from the first duration, now a data signal can be supplied to a pixel independently from the clock frequency of the selection circuitry (select driver). As a result, the selection circuitry can be operated at a relatively low clock frequency, which reduces the power consumption. A relatively broad data pulse is still supplied under control of the (basic) selection circuitry, but a relatively small data pulse is now supplied via the added means and independently of the (basic) selection circuitry.

The fact that the second duration is different from the first duration is to be looked at as follows. In a prior art situation, the duration of the selection signal and the first duration of a data pulse as supplied via data circuitry and controlled by the selection circuitry are substantially the same, where, according to the invention, the duration of the selection signal and the second duration of a data pulse as supplied via the added means are substantially different from each other (>1% deviation). Further, the invention also advantageously allows the supply, via the added means, of a data pulse which has an uninterrupted larger width compared to data pulses supplied via the data circuitry and controlled by the selection circuitry.

An embodiment of a display unit according to the invention is defined by the second duration being shorter than the first duration. In this case, shaking data pulses discussed below are supplied via the added means, and driving data pulses and reset data pulses discussed below are supplied via the data circuitry controlled by the selection circuitry. Due to for example the width of the driving data pulses now defining the clock frequency of the selection circuitry, which driving data pulses are much broader than the shaking data pulses, the selection circuitry can be clocked at a reduced clock frequency, and much power consumption is saved.

An embodiment of a display unit according to the invention is defined by a pixel being coupled to a common electrode, with the means comprising common electrode circuitry for driving the pixel via the common electrode. In this case, for example the shaking data pulses are supplied via the common electrode.

An embodiment of a display unit according to the invention is defined by a pixel being coupled to a storage capacitor, with the means comprising storage capacitor circuitry for driving the pixel via the storage capacitor. In this case, for example the shaking data pulses are supplied via the storage capacitors. Either all storage capacitors are coupled to the same storage capacitor line, in which case all pixels can be driven via the storage capacitors simultaneously. Or the storage capacitors coupled to pixels in a line are coupled to for example a neighboring line. Then, for example pixels in odd and even lines must be driven separately via the storage capacitors.

An embodiment of a display unit according to the invention is defined by one side of a pixel being coupled to a common electrode and an other side being coupled to a storage capacitor, with the means comprising common electrode circuitry and storage capacitor circuitry for driving the pixel via the common electrode and the storage capacitor in an anti phase way. In this case, for example the shaking data pulses are supplied to the pixels by sending a voltage signal of a first sign via the common electrode and by sending a voltage signal of a second, opposite sign via the storage capacitors. This allows the advantageous use of low power circuitry.

An embodiment of a display unit according to the invention is defined by the means comprising circuitry coupled to the selection circuitry for selecting at least two lines simultaneously. In this case, the (basic) selection circuitry is extended with the means for selecting at least two and preferably all lines simultaneously. Then, the driving data pulses and the reset data pulses are supplied under control of the (basic) selection circuitry, where the shaking data pulses are supplied via these means to the pixels in at least two and preferably all lines simultaneously and independently from (the clock frequency of) the selection circuitry.

An embodiment of a display unit according to the invention is defined by the means comprising circuitry coupled to data circuitry for coupling at least two data electrodes to each other. In this case, the data circuitry is extended with the means for coupling at least two and preferably all data electrodes to each other. Then, the driving data pulses and the reset data pulses are supplied under control of the selection circuitry, where the shaking data pulses are supplied via these means to the pixels coupled to at least two and preferably all data electrodes simultaneously and independently from (the clock frequency of) the selection circuitry.

An embodiment of a display unit according to the invention is defined by further comprising a controller, which is adapted to provide shaking data pulses, one or more reset data pulses, and one or more driving data pulses to the pixels. The shaking data pulses reduce the dependency of the optical response of the electrophoretic display unit on the history of the pixels. The shaking data pulses comprise pulses representing energies which are sufficient to release the electrophoretic particles from a static state at one of the two electrodes, but which are too low to allow the electrophoretic particles to reach the other one of the electrodes. Because of the reduced dependency on the history of the pixels, the optical response to identical data will be substantially equal, regardless of the history of the pixels. The underlying mechanism can be explained by the fact that, after the display device is switched to a predetermined state, for example a black state, the electrophoretic particles come to a static state. When a subsequent switching to the white state takes place, the momentum of the particles is low because their starting speed is close to zero. This results in a high dependency on the history of the pixels resulting in a long switching time to overcome this high dependency. The application of the shaking data pulses increases the momentum of the electrophoretic particles and thus reduces the dependency resulting in a shorter switching time. The reset data pulses precede the driving data pulses to further improve the optical response of the display unit, by defining a fixed starting point (fixed black or fixed white) for the driving data pulses. Alternatively, the reset data pulses precede the driving data pulses to further improve the optical response of the display unit, by defining a flexible starting point (black or white, to be selected in dependence of and closest to the gray value to be defined by the following driving data pulses) for the driving data pulses.

The display device may be an electronic book, while the storage medium for storing information may be a memory stick, an integrated circuit, a memory like an optical or magnetic disc or other storage device for storing, for example, the content of a book to be displayed on the display unit.

Embodiments of the method according to the invention and of the processor program product according to the invention correspond with the embodiments of the display unit according to the invention.

The invention is based upon an insight, inter alia, that, a given clock frequency of the selection circuitry defines the width of the data pulses to be supplied to the pixels under control of the selection circuitry, and is based upon a basic idea, inter alia, that, for a given clock frequency of the selection circuitry, additional means are to be introduced for supplying data pulses having a different duration.

The invention solves the problem, inter alia, to provide a display unit in which a data pulse having a relatively small width can be provided to a pixel where the select driver is clocked by a relatively low clock frequency, and is advantageous, inter alia, in that the display unit has a relatively low power consumption.

These and other aspects of the invention will be apparent from and elucidated with reference to the embodiments(s) described hereinafter.

In the drawings:

FIG. 1 shows (in cross-section) a bi-stable pixel;

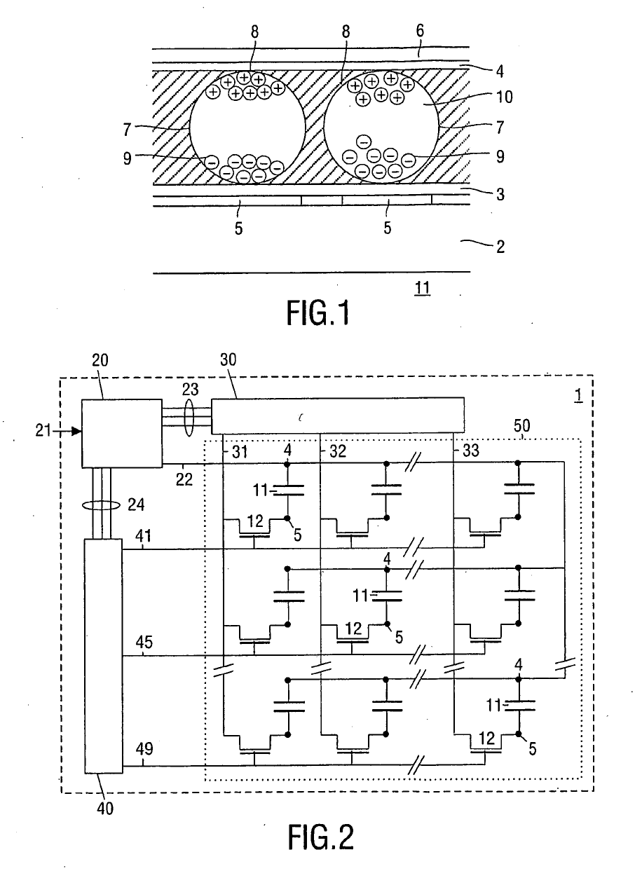

FIG. 2 shows diagrammatically a display unit;

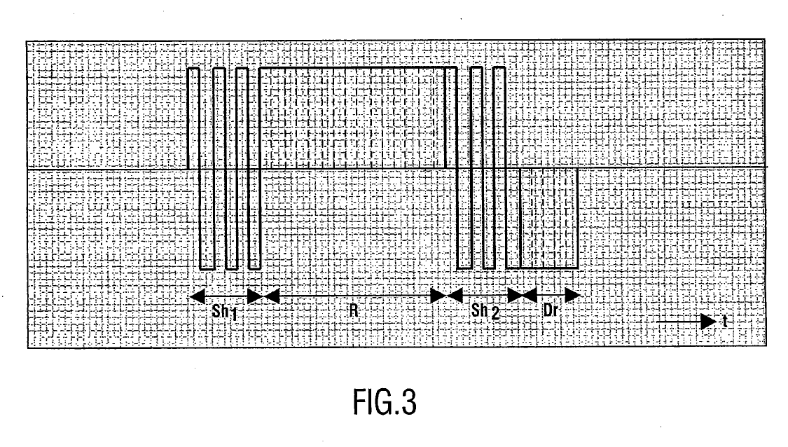

FIG. 3 shows a waveform for driving a display unit;

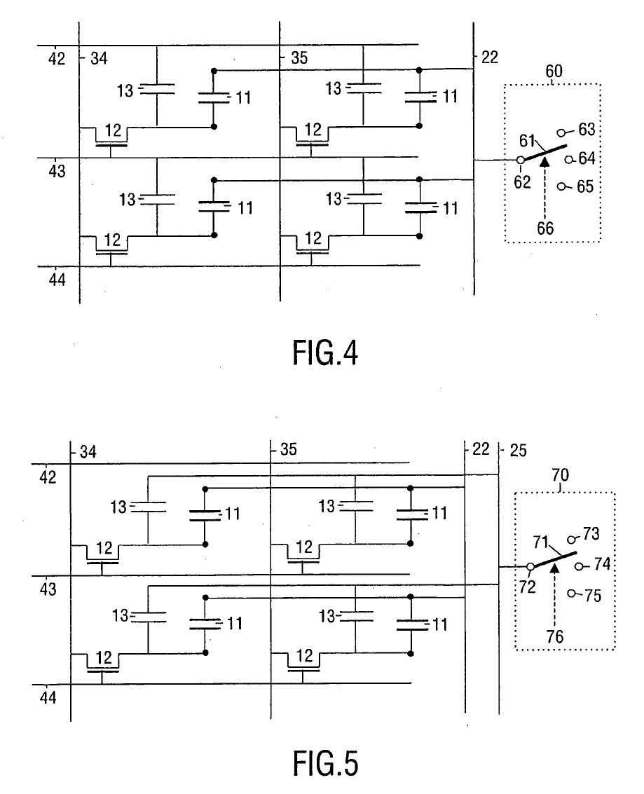

FIG. 4 shows diagrammatically a part of a display panel comprising pixels coupled via a common electrode to common electrode circuitry;

FIG. 5 shows diagrammatically a part of a display panel comprising pixels coupled via storage capacitors to storage capacitor circuitry;

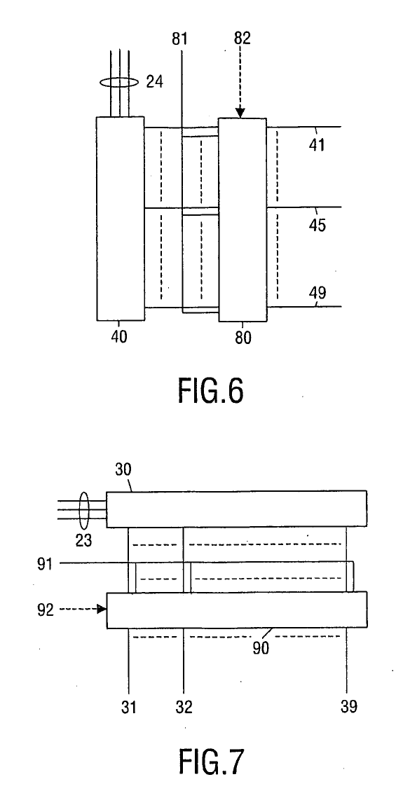

FIG. 6 shows diagrammatically selection circuitry coupled to circuitry for selecting at least two lines simultaneously; and

FIG. 7 shows diagrammatically data circuitry coupled to circuitry for coupling at least two data electrodes to each other.

The bi-stable pixel 11 of the display unit shown in FIG. 1 (in cross-section) comprises a bottom substrate 2 (like plastic or glass), an electrophoretic film (laminated on base substrate 2) with an electronic ink which is present between a glue layer 3 and a common electrode 4. The glue layer 3 is provided with transparent pixel electrodes 5. The electronic ink comprises multiple microcapsules 7 of about 10 to 50 microns in diameter. Each microcapsule 7 comprises positively charged white particles 8 and negatively charged black particles 9 suspended in a fluid 10. When a positive voltage is applied to the pixel electrode 5, the white particles 8 move to the side of the microcapsule 7 directed to the common electrode 4, and the pixel becomes visible to a viewer. Simultaneously, the black particles 9 move to the opposite side of the microcapsule 7 where they are hidden from the viewer. By applying a negative voltage to the pixel electrode 5, the black particles 9 move to the side of the microcapsule 7 directed to the common electrode 4, and the pixel appears dark to a viewer (not shown). When the electric voltage is removed, the particles 8,9 remain in the acquired state and the display exhibits a bi-stable character and consumes substantially no power. In alternative systems, particles may move in an in-plane direction, driven by electrodes which may be situated on the same substrate.

The (electrophbretic) display unit 1 shown in FIG. 2 comprises a display panel 50 comprising a matrix of pixels 11 at the area of crossings of line or row or selection electrodes 41,45,49 and column or data electrodes 31,32,39. These pixels 11 are all coupled to a common electrode 22, and each pixel 11 is coupled to its own pixel electrode 5. The display unit 1 further comprises selection driving circuitry 40 (line or row or selection driver) coupled to the row electrodes 41,45,49 and data driving circuitry 30 (column or data driver) coupled to the column electrodes 31,32,39 and comprises per pixel 11 an active switching element 12. The display unit 1 is driven by these active switching elements 12 (in this example (thin-film) transistors). The selection driving circuitry 40 consecutively selects the row electrodes 41,45,49, while the data driving circuitry 30 provides data signals to the column electrode 31,32,39. Preferably, a controller 20 first processes incoming data arriving via input 21 and then generates the data signals. Mutual synchronization between the data driving circuitry 30 and the selection driving circuitry 40 takes place via drive lines 23 and 24. Selection signals from the selection driving circuitry 40 select the pixel electrodes 5 via the transistors 12 of which the drain electrodes are electrically coupled to the pixel electrodes 5 and of which the gate electrodes are electrically coupled to the row electrodes 41,45,49 and of which the source electrodes are electrically coupled to the column electrodes 31,32,39. A data signal present at the column electrode 31,32,39 is simultaneously transferred to the pixel electrode 5 of the pixel 11 coupled to the drain electrode of the transistor 12. Instead of transistors, other switching elements can be used, such as diodes, MIMs, etc. The data signals and the selection signals together form (parts of) driving signals.

Incoming data, such as image information receivable via input 21 is processed by controller 20. Thereto, controller 20 detects an arrival of new image information about a new image and in response starts the processing of the image information received. This processing of image information may comprise the loading of the new image information, the comparing of previous images stored in a memory of controller 20 and the new image, the interaction with temperature sensors, the accessing of memories containing look-up tables of drive waveforms etc. Finally, controller 20 detects when this processing of the image information is ready.

Then, controller 20 generates the data signals to be supplied to data driving circuitry 30 via drive lines 23 and generates the selection signals to be supplied to selection driving circuitry 40 via drive lines 24. These data signals comprise data-independent signals which are the same for all pixels 11 and data-dependent signals which may or may not vary per pixel 11. The data-independent signals comprise shaking data pulses, with the data-dependent signals comprising one or more reset data pulses and one or more driving data pulses. These shaking data pulses comprise pulses representing energy which is sufficient to release the (electrophoretic) particles 8,9 from a static state at one of the two electrodes 5,6, but which is too low to allow the particles 8,9 to reach the other one of the electrodes 5,6. Because of the reduced dependency on the history, the optical response to identical data will be substantially equal, regardless of the history of the pixels 11. So, the shaking data pulses reduce the dependency of the optical response of the display unit on the history of the pixels 11. The reset data pulse precedes the driving data pulse to further improve the optical response, by defining a flexible starting point for the driving data pulse. This starting point may be a black or white level, to be selected in dependence on and closest to the gray value defined by the following driving data pulse. Alternatively, the reset data pulse may form part of the data-independent signals and may precede the driving data pulse to further improve the optical response of the display unit, by defining a fixed starting point for the driving data pulse. This starting point may be a fixed black or fixed white level.

In FIG. 3, a waveform representing voltages across a pixel 11 as a function of time t is shown for driving an (electrophoretic) display unit 1. This waveform is generated using the data signals supplied via the data driving circuitry 30. The waveform comprises first shaking data pulses Sh₁, followed by one or more reset data pulses E, second shaking data pulses Sh₂ and one or more driving data pulses Dr. For example sixteen different waveforms are stored in a memory, for example a look-up table memory, forming part of and/or coupled to the controller 20. In response to data received via input 21, controller 20 selects a waveform for a pixel 11, and supplies the corresponding selection signals and data signals via the corresponding driving circuitry 30,40 and via the corresponding transistors 12 to the corresponding pixels 11.

A frame period corresponds with a time-interval used for driving all pixels 11 in the display unit 1 once (by driving each row one after the other and by driving all columns simultaneously once per row). For supplying data-dependent or data-independent signals to the pixels 11 during frames, the data driving circuitry 30 is controlled in such a way by the controller 20 that all pixels 11 in a row receive these data-dependent or data-independent signals simultaneously. This is done row by row, with the controller 20 controlling the selection driving circuitry 40 in such a way that the rows are selected one after the other (all transistors 12 in the selected row are brought into a conducting state).

During a first set of frames, the first and second shaking data pulses Sh₁ and Sh₂ are supplied to the pixels 11, with each shaking data pulse having a duration of one frame period. The starting shaking data pulse for example has a positive amplitude, the next one a negative amplitude, and the next one a positive amplitude. etc. Therefore, these alternating shaking data pulses do not change the gray value displayed by the pixel 11, as long as the frame period is relatively short.

During a second set of frames comprising one or more frames periods, a combination of reset data pulses R is supplied, further to be discussed below. During a third set of frames comprising one or more frames periods, a combination of driving data pulses Dr is supplied, with the combination of driving data pulses Dr either having a duration of zero frame periods and in fact being a pulse having a zero amplitude or having a duration of one, two to for example fifteen frame periods. Thereby, a driving data pulse Dr having a duration of zero frame periods for example corresponds with the pixel 11 displaying full black (in case the pixel 11 already displayed full black; in case of displaying a certain gray value, this gray value remains unchanged when being driven with a driving data pulse having a duration of zero frame periods, in other words when being driven with a data pulse having a zero amplitude). The combination of driving data pulses Dr having a duration of fifteen frame periods comprises fifteen subsequent pulses and for example corresponds with the pixel II displaying full white, and the combination of driving data pulses Dr having a duration of one to fourteen frame periods comprises one to fourteen subsequent data pulses and for example corresponds with the pixel 11 displaying one of a limited number of gray values between full black and full white.

The reset data pulses R precede the driving data pulses Dr to further improve the optical response of the display unit 1, by defining a fixed starting point (fixed black or fixed white) for the driving data pulses Dr. Alternatively, reset data pulses R precede the driving data pulses Dr to further improve the optical response of the display unit, by defining a flexible starting point (black or white, to be selected in dependence of and closest to the gray value to be defined by the following driving data pulses) for the driving data pulses Dr.

In FIG. 4, a part of the display panel 50 is shown diagrammatically. This part comprises four pixels 11. A first pixel 11 is coupled via a transistor 12 to a row electrode 43 and to a column electrode 34. A second pixel 11 is coupled via a transistor 12 to the row electrode 43 and to a column electrode 35. A third pixel 11 is coupled via a transistor 12 to a row electrode 44 and to the column electrode 34. A fourth pixel 11 is coupled via a transistor 12 to the row electrode 44 and to the column electrode 35. The first and second pixel 11 are each coupled via a storage capacitor 13 to a previous row electrode 42, and the third and fourth pixel 11 are each coupled via a storage capacitor 13 to the previous row electrode 43. The pixels 11 are further coupled to the common electrode 22.

The storage capacitors 13 improve the stability of the signals on the pixels 11. By coupling the storage capacitors to a previous row electrode (or alternatively to a next row electrode), a separate storage line is avoided. The driving of a row disturbs, via the storage capacitors 13, the signals on the pixels 11 in the next row relatively little, due to the row driving signals being relatively short. Most of the time, a row is not driven and its row electrode is at a predefined voltage.

The common electrode 22 shown in FIG. 4 is further coupled to common electrode circuitry 60, which comprises a switch 61 of which a main contact 62 is coupled to the common electrode 22. Switching contacts 63, 64 and 65 respectively for example receive a common mode voltage, a positive voltage and a negative voltage respectively. The switch 61 is controlled via the controller 20 as indicated by arrow 66. When supplying driving data pulses and reset data pulses to the pixels 11 via the transistors 12, the switch 61 is coupled to the switching contact 63. For supplying positive (negative) shaking data pulses to the pixels 11, the switch 61 is to be coupled to the switching contact 64 (65). So, the shaking data pulses arrive in this case via the common mode 22, and the selection circuitry 40 can be clocked at a relatively low clock frequency, due to the driving data pulses and the reset data pulses being broader than the shaking data pulses. A first duration of a selection signal for selecting a line can now be much longer than a second duration of a shaking data pulse. During supplying the shaking pulses this way to the pixels 11, the lines are for example not selected. Alternatively, for example one line may be selected at the time, or for example two or more lines may be selected simultaneously (see FIG. 6), for supplying for example a low-voltage signal via the transistors 12 to the pixels 11 in the selected line(s).

In FIG. 5, a part of the display panel 50 is shown diagrammatically. This part corresponds with the part shown in FIG. 4, apart from the fact that each storage capacitor 13 is not coupled to a previous row but is now coupled to a storage line 25. This storage line 25 is coupled to storage capacitor circuitry 70, which comprises a switch 71 of which a main contact 72 is coupled to the storage line 25. Switching contacts 73, 74 and 75 respectively for example receive a storage line voltage, a positive voltage and a negative voltage respectively. The switch 71 is controlled via the controller 20 as indicated by arrow 76. When supplying driving data pulses and reset data pulses to the pixels 11 via the transistors 12, the switch 71 is coupled to the switching contact 73. For supplying positive (negative) shaking data pulses to the pixels 11, the switch 71 is to be coupled to the switching contact 74 (75). So, the shaking data pulses arrive in this case via the storage line 25, and, again, the selection circuitry 40 can be clocked at a relatively low clock frequency, due to the driving data pulses and the reset data pulses being broader than the shaking data pulses. The first duration of the selection signal for selecting a line can now again be much longer than the second duration of a shaking data pulse. During supplying the shaking pulses this way to the pixels 11, the lines are for example not selected, and the transistors 12 are in a non-conductive state. Preferably a DC-voltage signal is supplied to the lines, to bring the transistors 12 into a non-conductive, high-impedance state.

Switches 61,71 for example comprise one or more transistors, and/or one or more diodes etc. Both embodiments shown in FIG. 4 and FIG. 5 can be combined, in which case the switches 61 and 71, when supplying the shaking data pulses, are to be operated in an anti phase way. This is done by either coupling switch 61 to switching contact 64 and simultaneously coupling switch 71 to switching contact 75, and vice versa, or by interchanging the contacts 64,65 (or 74,75) etc. Then, the switching contacts 64,65,74,75 need to receive only half the voltages they used to receive in the non-combined situation. This results in less power consumption in circuitry 60,70.

In FIG. 6, the selection circuitry 40 is coupled to circuitry 80 for selecting at least two lines 41,45,49 simultaneously. Thereto, the circuitry 80 for example comprises a multiplexer of which first inputs are coupled to outputs of the selection circuitry 40 and of which second inputs are coupled to each other and to an electrode 81 for receiving a selection voltage. Outputs of the multiplexer are coupled to the lines 41,45,49. The multiplexer is controlled via the controller 20 as indicated by arrow 82. When supplying driving data pulses and reset data pulses to the pixels 11 via the transistors 12, the multiplexer couples its first inputs to the lines 41,45,49. For supplying shaking data pulses to the pixels 11, now also via the transistors 12, the multiplexer couples its second inputs to the lines 41,45,49. So, the shaking data pulses arrive in this case also via the transistors 12, but without the selection circuitry 40 needing to be clocked at a relatively high clock frequency, due to the multiplexer taking care of selecting at least two and preferably all lines 41,45,49 for simultaneously supplying the shaking data pulses to the pixels 11.

In this case, the shaking data pulses are provided via the data circuitry 30, with the controller 20 taking care of controlling this data circuitry 30. Of course, instead of a multiplexer, other circuits can be used for implementing the circuitry 80. This circuitry 80 may further be integrated into the selection circuitry 40, partly or entirely. Again, the first duration of the selection signal for selecting a line can now be much longer than the second duration of a shaking data pulse.

In FIG. 7, the data circuitry 30 is coupled to circuitry 90 for coupling at least two data electrodes 31,32,39 to each other. Thereto, the circuitry 90 for example comprises a multiplexer of which first inputs are coupled to outputs of the data circuitry 30 and of which second inputs are coupled to each other and to an electrode 91 for receiving a shaking data pulse voltage. Outputs of the multiplexer are coupled to the data electrodes 31,32,39. The multiplexer is controlled via the controller 20 as indicated by arrow 92. When supplying driving data pulses and reset data pulses to the pixels 11 via the transistors 12, the multiplexer couples its first inputs to the data electrodes 31,32,39. For supplying shaking data pulses to the pixels 11, now also via the transistors 12, the multiplexer couples its second inputs to the data electrodes 31,32,39. So, the shaking data pulses arrive in this case also via the transistors 12, but without the selection circuitry 40 needing to be clocked at a relatively high clock frequency, due to the multiplexer taking care of coupling at least two and preferably all data electrodes 31,32,39 to each other for simultaneously supplying the shaking data pulses to the pixels 11 line per line. In this case, more than one shaking data pulse may be provided to each pixel 11 in a line 41,45,49 during the selection of that line 41,45,49. In combination with the embodiment as disclosed in FIG. 6, this may alternatively be done for all lines simultaneously.

Instead of a multiplexer, other circuits can be used for implementing the circuitry 90. This circuitry 90 may further be integrated into the data circuitry 30, partly or entirely. Again, the first duration of the selection signal for selecting a line can now be much longer than the second duration of a shaking data pulse.

Generally, the selection circuitry 40 selects, during a period of a first duration, a line with pixels 11, and the means 30,60,70,80,90 are arranged to allow the supply of a data signal to a pixel 11, which data signal comprises a pulse of a second duration, which second duration is different from the first duration. So, according to an embodiment of the lowest complexity, the means just comprise the data circuitry 30 operating at a different clock frequency than the selection circuitry 40, or, alternatively, the data circuitry 30 then supplies data signals comprising data pulses having a duration which does not correspond with the clock frequency at which the selection circuitry 40 is clocked.

Controller 20 comprises and/or is coupled to a memory (not shown) like, for example, a look-up table memory for storing information about the waveforms. The invention is not limited to electrophoretic display panels but can be used for any display panel based on bi-stable pixels. Each two or more of the above described embodiments can be combined advantageously. Instead of using the invention for the supply of the shaking pulses, other purposes can be served, like for example erasing, resetting and/or presetting the display unit 1 independently from the clock frequency at which the selection circuitry 40 is clocked. In an advantageous embodiment, a number of lines (rows) is selected simultaneously. Then, the frame period is shorter, and the update rate is higher. For example, in case of ten rows being selected simultaneously, the frame period may be ten times shorter, and the update rate may be ten times higher. Of course, in this case, the pixels 11 in the ten lines will receive per column the same information.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A display unit (1) comprising
a display panel (50) with bi-stable pixels (11);
selection circuitry (40) for, during a period of a first duration, selecting a line with pixels (11); and
means (30,60,70,80,90) for supplying a data signal to a pixel (11), which data signal comprises a pulse of a second duration, which second duration is different from the first duration.

2. A display unit (1) as claimed in claim 1, wherein the second duration is shorter than the first duration.

3. A display unit (1) as claimed in claim 1, wherein a pixel (11) is coupled to a common electrode (22), with the means comprising common electrode circuitry (60) for driving the pixel (11) via the common electrode (22).

4. A display unit (1) as claimed in claim 1, wherein a pixel (11) is coupled to a storage capacitor (13), with the means comprising storage capacitor circuitry (70) for driving the pixel (11) via the storage capacitor (13).

5. A display unit (1) as claimed in claim 1, wherein one side of a pixel (11) is coupled to a common electrode (22) and an other side is coupled to a storage capacitor (13), with the means comprising common electrode circuitry (60) and storage capacitor circuitry (70) for driving the pixel (11) via the common electrode (22) and the storage capacitor (13) in an anti phase way.

6. A display unit (1) as claimed in claim 1, wherein the means comprise circuitry (80) coupled to the selection circuitry (40) for selecting at least two lines (41,45,49) simultaneously.

7. A display unit (1) as claimed in claim 1, wherein the means comprise circuitry (90) coupled to data circuitry (30) for coupling at least two data electrodes (31,32,39) to each other.

8. A display unit (1) as claimed in claim 1, further comprising a controller (20), which is adapted to provide:
shaking data pulses (Sh₁,Sh₂);
one or more reset data pulses (R); and
one or more driving data pulses (Dr);
to the pixels (11).

9. A display device comprising a display unit (1) as claimed in claim 1 and further comprising a storage medium for storing information to be displayed.

10. A method for driving a display unit (I) comprising
a display panel (50) with bi-stable pixels (11); and
selection circuitry (40) for, during a period of a first duration, selecting a line with pixels (11);
which method comprises a step of supplying a data signal to a pixel (11), which data signal comprises a pulse of a second duration, which second duration is different from the first duration.

11. A processor program product for driving a display unit (1) comprising
a display panel (50) with bi-stable pixels (11); and
selection circuitry (40) for, during a period of a first duration, selecting a line with pixels (11);
which processor program product comprises a function of supplying a data signal to a pixel (11), which data signal comprises a pulse of a second duration, which second duration is different from the first duration.
